(19) United States
(12) Patent Application Publication
(10) Pub. No.: US 2004/0184590 A1
(43) Pub. Date: Sep. 23, 2004

(54) Device and method for caller identification

(76) Inventor: Xiaohao Jia, Westport, CT (US)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(21) Appl. No.: 10/393,601

(22) Filed: Mar. 21, 2003

(51) Int. Cl. H04M 1/56; H04M 15/06

(52) U.S. Cl. 379/142.04

(57) ABSTRACT

A caller identification is disclosed. The inventive system requires no visual check of incoming calls and results in complete elimination of unwanted call interruptions. In addition, the system may be implemented without subscription services and with a minimum of effort in multiple locations, portably, temporarily and/or on a permanent basis. A logic circuit is coupled to a telephone line and connected to receive caller identification codes. A random access memory is coupled to the logic circuit to receive and store the caller identification codes. The random access memory has stored therein a plurality of different signal sounds, each of the signal sounds having a respective associated signal sound identifier associated with a respective caller identification code. An input device, such as a keypad, is coupled to the logic circuit and configured to generate an output signal which comprises a caller identification code and the associated signal sound identifier. A sound producing device is coupled to the random access memory to play back a respective one of the signal sounds in response to receipt by the logic circuit of its respective caller identification code.

### TECHNICAL FIELD

The present invention relates to portable telephone caller identification devices in the form of devices which are incorporated into cordless, cellular and other telephones, such as single line consumer telephones meant for home use, but also applicable to commercial and multiline systems.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Given the rapid pace of life, very few of us have much free time. Moreover, what little free time we do have is a precious commodity distributed between the various important parts of our lives, such as time with our families, the pleasure of the evening meal, ferrying the children to various activities, and, perhaps, a few minutes to watch the news or a favorite television program.

Nuisance telephone calls have for many years presented a substantial disturbance to domestic peace and tranquility. Typically, telemarketers target consumers at home, typically during or close to the dinner hour. We are long past the early days of the telephone, when many people refused to have them in their homes, and when the telephone was considered, at least by some, an infringement on a peaceable and enjoyable lifestyle. Not surprisingly, a number of strategies and devices have arisen to deal with the telephone as the pervasive presence which it is in American life.

An early attempt to deal with the problem was the telephone answering machine. Telephone answering machines allow consumers simply to ignore the telephone. In one variation, the caller placing the call is given the opportunity to leave a message. Accordingly, if the consumer chooses to do so, as this message is being given, it may also be put on a loudspeaker, allowing screening of the call. If the recipient of the call desires, he can interrupt the message and pick up the call at anytime. However, a large part of the disturbance still remains, and attention to the incoming message was a disruption that could come at relatively inopportune times.

Still another problem with the telephone answering approach is the accumulation of a potentially large number of messages which had to be dealt with, if only to be listened to.

To a certain extent, these concerns are addressed by so-called caller ID systems which take the form of alphanumeric displays included on telephones, and which display the telephone number of the instrument from which the consumer's telephone is being called. However, caller ID systems suffer from numerous disadvantages. The need for a display adds cost to the instrument. Caller ID service may not be available at all locations and may not extend to the location from which the call is being made. Moreover, it is necessary to view the display in order to identify the caller, resulting in sometimes substantial inconvenience. In addition to this, caller ID is specific to the instrument making the call, not the individual calling. Thus, if, for example, the child of a consumer is calling and the consumer is predisposed to take that call, but the expected calling cellular telephone has a dead battery and the child is forced to call from another instrument, the caller will not be identified by a caller ID system. In addition, caller ID has substantial costs which must be paid every month by the consumer subscriber. Finally, caller ID is not only keyed to the instrument from which the call is being made, but it is also specific to the particular receiving line.

### SUMMARY OF THE INVENTION

In accordance with the invention, caller identification is provided in a manner which solves the above problems. The inventive system requires no visual check of incoming calls and results in complete elimination of unwanted call interruptions. In addition, the system may be implemented without subscription services (and their associated costs) and with a minimum of effort in multiple locations, temporarily or on a permanent basis.

More particularly, in accordance with the invention, a caller identification device comprises a logic circuit coupled to a telephone line and connected to receive caller identification codes. A random access memory stores information. The random access memory is coupled to the logic circuit to receive and store the caller identification codes. The random access memory has stored therein a plurality of different signal sounds, each of the signal sounds having a respective associated signal sound identifier. Each of the signal sounds is associated with a respective caller identification code. An input device, such as a keypad, is coupled to the logic circuit. The input device is configured to generate an output signal which comprises a caller identification code and the associated signal sound identifier. The caller identification code and the associated signal sound identifier is coupled to the logic circuit for storage in the random access memory. A sound producing device is coupled to the random access memory to play back a respective one of the signal sounds in response to receipt by the logic circuit of its respective caller identification code.

The caller identification code may be a code input by a person calling on the telephone line in accordance with the preferred embodiment. The caller identification code may be a caller identification signal appearing on the telephone line.

The signal sounds may be selected from the group comprising dog sounds, cat sounds, duck sounds, bird sounds and other animal sounds.

In accordance with the preferred embodiment the caller identification device may be incorporated into a telephone, which may be a cordless telephone or cellular telephone, with the sound producing device giving the indication of an incoming call being located on the handset. Alternatively, in a cordless, corded, or cellular system, a headset may replace the handset, the sound producing device comprising the earphone of the headset.

In accordance with the preferred embodiment the caller identification device may further comprising a telephone answering circuit.

As part of the setup procedure, the identification code is input into the caller identification device by the user of the caller identification device, as part of a setup procedure. The identification code is input into the caller identification device using a keypad having a button which signals that a code is about to be entered, and stored by an enter key.

The inventive method of identifying a caller on a telephone instrument, comprises the steps of programming a caller identification device by inputting a caller identification code, inputting an associated signal sound, and giving an indication of the identity of a caller by receiving a call, receiving a caller identification code, and producing a sound associated with the caller identification code. The sound is produced on a headset or a cordless handset associated with the telephone instrument.

The inventive data structure in the caller identification device, comprises a plurality of signal sounds, a plurality of identification codes. Each of the identification codes is associated with a signal sound. A plurality of identification codes may be associated with a single signal sound.

### BRIEF DESCRIPTION OF THE DRAWINGS

The implementation of the invention may be understood in conjunction with the written description of the invention contained herein taken together with the following drawings, which illustrate only several embodiments of the invention, and in which:

FIG. 1 is a flowchart illustrating the operation of an appliance in accordance with the method of the present invention;

FIG. 2 is a flowchart illustrating the operation of an appliance in accordance with an alternative version of the method of the present invention;

FIG. 3 is a flowchart illustrating the operation of an appliance in accordance with another alternative version of the method of the present invention;

FIG. 4 is a flowchart illustrating the programming of an appliance in accordance with the version of the method of the present invention illustrated in FIG. 2;

FIG. 5 is a schematic diagram of a device constructed in accordance with the present invention;

FIG. 6 illustrates the device illustrated in FIG. 5;

FIG. 7 illustrates a cordless consumer telephone constructed in accordance with the present invention;

FIG. 8 is a flowchart illustrating the operation of inventive device in accordance with still another alternative version of the method of the present invention; and

FIG. 9 is a flowchart illustrating the operation of another alternative appliance in accordance with the method of the present invention.

### DETAILED DESCRIPTION OF THE BEST MODE

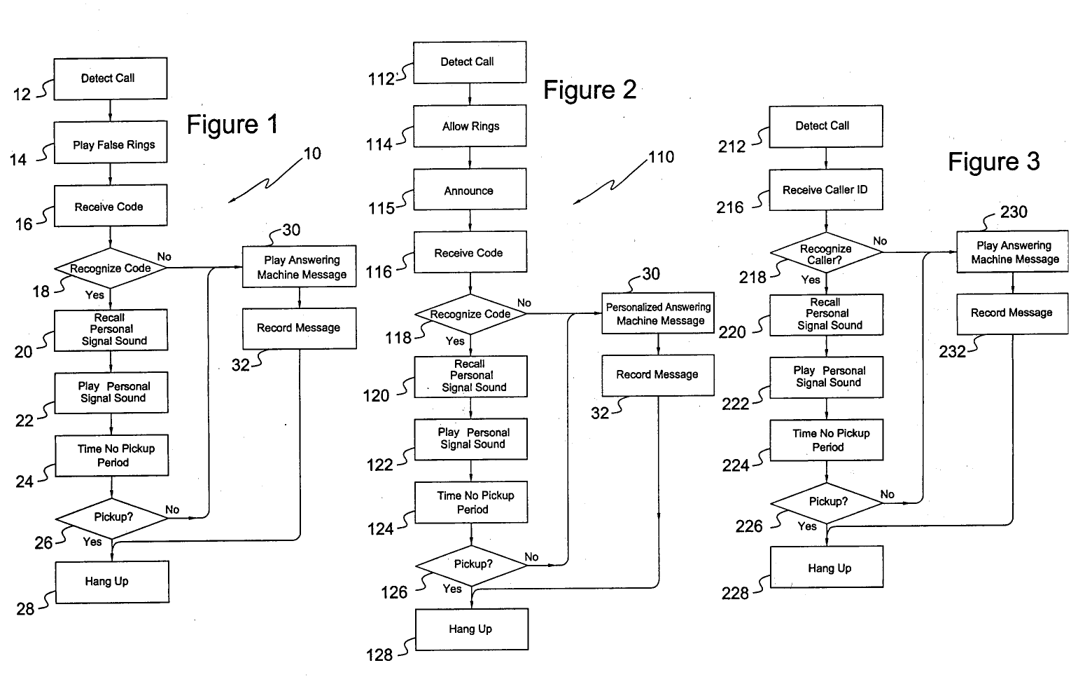

Referring to FIG. 1, the operation 10 of a caller identification system constructed in accordance with the present invention may be understood. When an incoming call is detected at step 12, the system picks up the line. Next, a series of false rings are generated by the system, and these synthesized ringing sounds are played back over the telephone line to the caller. In accordance with the invention, the caller keys in a personalized code which is received by the system at step 16. Alternatively, voice recognition software may be used to recognize a password spoken by the caller and/or the identity of the person calling.

If the code is recognized (or if the identity of the speaker and/or the password has been recognized by the voice recognition software), at step 18 the system proceeds to step 20 where the software recalls the personal signal sound associated with the recognized code. At step 22 this sound is played back by the system, for example, to a loudspeaker on the inventive device (or a loudspeaker on the telephone, in the event that the inventive device is incorporated into a cordless telephone, as will be described below).

At step 24 the system measures the period of time which has passed since the system generated the personal signal sound associated with the recognized code. If, after a preselected period of time (for example five rings or playbacks of the personal signal sound), the telephone handset has been picked up by the recipient of the call, this is determined at step 26, and the system proceeds to step 28 where the device hangs up on the telephone line, leaving the recipient of the call to continue the conversation. If, on the other hand, the recipient has not picked up the telephone handset within the preselected period of time, the system proceeds at step 26 to step 30 where an answering machine message is played to the caller, followed by a prompt, such as a tone or beep. At the tone, the system is prepared at step 32 to record a message from the caller. After the message is recorded or the maximum time for a message has elapsed, the system proceeds to step 28 where the system hangs up on the telephone line.

Personal signal sounds may take a wide variety of forms. The system may be programmed with various sounds which take the place of a conventional bell ringing sound. For example, the system may include a dog barking sound, a cat meowing sound, a bird singing sound and the duck quacking sound. Alternatively, other sounds may be used such as musical instruments (drum, trumpet, organ, saxophone, cymbals, etc.), weather sounds (waves, thunder, a babbling brook, rain, or howling wind), or different short melodies. In addition, different songs or other sounds may be downloaded onto the inventive device over the telephone. The system may be programmed, for example, to produce the dog barking sound when the consumer's son is calling, to produce the cat meowing sound when the consumer's daughter is calling, to produce the bird singing sound when the consumer's wife is calling, and to produce the duck quacking sound when the consumer's boss is calling.

In accordance with this embodiment, when the wife of the consumer calls home, for example, the system will receive her personal identification code, and her husband, instead of hearing a telephone ringing in a conventional way, will hear a bird singing. On the other hand, if an other person calls the same telephone number, by putting in the personal code of that other person, causes the system to produce his or her own personal signal sound. Finally, if an unauthorized individual calling does not know to put in a code while the telephone is ringing with the false rings, the unauthorized individual will simply continue to hear a conventional bell ringing sound until he or she hangs up.

In accordance with the preferred embodiment of the invention, in the event that a code is not given or recognized by the system, and the user has selected so, the telephone will continue to make its generalized ring. Alternatively, if the telephone ringer has been disabled, the system may include ringing sound which will be either particularized to a particular caller or of a general nature if the caller is not recognized. Also, in accordance with consumer selection, a general ring may be produced in the period before the caller is identified or not identified.

FIG. 2 illustrates two optional features which may be incorporated into the method of the present invention. In this embodiment, as in later embodiments, parts performing analogous or identical functions are labeled with numbers which are a multiple of 100 different from the corresponding parts in the earlier embodiment for the purpose of conciseness of description, but may not be further described.

More particularly, in the FIG. 2 embodiment, operation of the inventive methodology 110 is substantially identical to the operation of the methodology 10 illustrated in FIG. 1. However, instead of playing false rings, at step 114 the system merely allows the line to ring and then picks up the line at step 115 and instructs the caller to put in a personal code or, for example, depress the “0” key to leave a message. If a code is not received within a period of time or if the “0” key is depressed, the system proceeds to steps 130 and 132, where a message is taken. If, the other hand, a code is recognized, the system proceeds through steps 120-128 in a manner identical to that of steps 20-28.

In accordance with this embodiment of the invention, each caller with an identification code, in addition to being given a personalized ringing sound, also gets a personalized message. It is contemplated in accordance with the invention, that this personalized message may change from time to time for the individual caller, particularly when a call from that individual is expected.

Still another approach to the inventive system is the incorporation of caller ID technology, as illustrated in the method illustrated in FIG. 3. In this embodiment, when a call is detected at step 212, the system will accept at step 216 caller identification information in the form of the caller identification information provided by the telephone company or in the form of a keyed in code entered by the caller in the manner of the FIG. 1 embodiment. The system than proceeds to step 218, after which the operation of the system is substantially identical to that illustrated in FIG. 1.

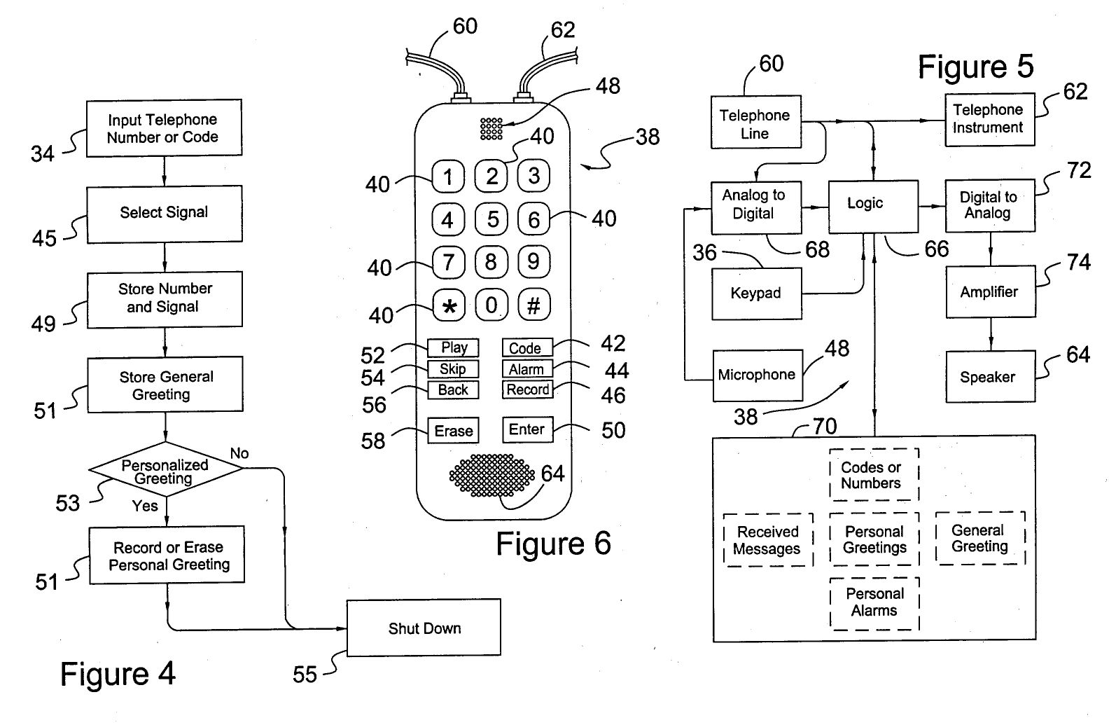

In accordance with the invention, it is necessary for the consumer to enter in the code and/or telephone number for persons who will be given personalized signal sounds, as part of a setup process for the inventive device. The information entering aspect of the inventive method is illustrated in flowchart form in FIG. 4. At step 34, the consumer enters the telephone number or code of the individual using a keypad 36 associated with the inventive system 38, as illustrated in FIG. 5. As illustrated in FIG. 6, a keypad 36 can take a relatively conventional form comprising a number of keys 40 assigned numbers and/or other a alphanumeric symbols.

Initiation of the code entry sequence input at step 34 is started by depression of code key 42, followed by depression of the appropriate number keys 40. Next, the user depresses alarm key 44. At step 45, the system receives the personalized signal sound selected by the user. Such selection takes the following form. Each time alarm key 44 is depressed, one of the personal signal sounds is played. When the desired personal signal sound has been heard, for example the bird singing, the code number and signal may then be stored by the system at step 49, by depression of the enter key 50.

If the inventive system 38 incorporates a personalized message feature, the record button 46 is depressed. At this point, the user speaks into microphone 48, and records a personal message for the recognized caller. Alternatively, a general greeting may be stored by the system at step 51. The system may determine whether a general or personalized greeting is desired by the user by prompting the user at step 53 with an audible question stored in system random access memory. At step 53, the system either proceeds to shut down at step 55 if there is no personal greeting or change in existing personal greeting, the system proceeds to record such a greeting at step 57. When the code, alarm selection and optionally personalized message have been entered, enter key 50 is depressed. The system is then ready to receive and identify the entered caller.

In accordance with the invention, it is also contemplated that the inventive system may be incorporated into a telephone answering device. As illustrated in FIG. 6, the typical telephone answering functions may be accessed through the typical buttons, including a play message button 52, a skip message button 54, a backup to previous message button 56, and a message erase button 58.

In the illustrated example, a line 60 is provided to connect to the telephone system and a line 62 is provided to connect to a conventional telephone instrument. Finally, the selective ringing sound is provided through a speaker 64.

Referring to FIG. 5, when a telephone call is received over telephone line 60, the ringing of the incoming call is detected by logic circuit 66, which picks up the line, as described above, and then receives the telephone company or caller originated caller identification information, corresponding to information input by the user using keypad 36.

Personalized announcements are input into the system by microphone 38, which passes this information to analog to digital converter 68, which sends the announcement in digital form through logic circuit 66 for storage in random access memory 70. Likewise, received messages are received by analog to digital circuit 68 from telephone line 60 and routed through logic circuit 66 to random access memory 70 for later recall in response to system commands, all of which are input using keypad 36. Random access memory also stores the various personal signals or personal alarms which are routed to digital to analog converter 72 in accordance with the above-described algorithms.

Personal signals, such as the bird singing, are presented to the user by amplifying the output of digital to analog converter 72, using an amplifier 74, which, in turn, drives speaker 64.

Still another alternative in accordance with the present invention is the provision of the inventive system within a conventional cordless telephone 176. Telephone 176 includes a handset 178 which has a speaker 180, through which the caller listens to the person to whom he is speaking, and which functions to play back the personal signal sounds where ever the battery-powered handset 178 is located.

Alternatively, the system may utilize a headset comprising an earphone (instead of a speaker) and a microphone on a boom (in place of the handset microphone).

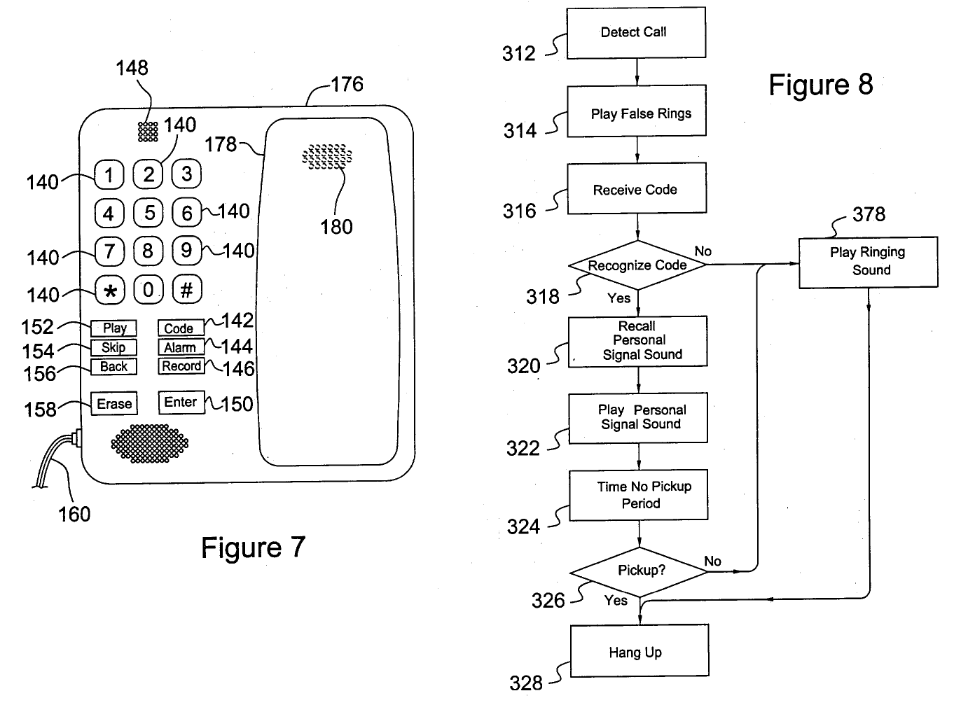

In accordance with the embodiment of the invention illustrated in FIG. 7, telephone 176 includes answering machine functions as well as the inventive personalized ringing functions. Naturally, because the inventive system and an answering machine are incorporated in telephone 176, only a single line 160 for connecting to the telephone line is included.

A greatly simplified version of the inventive system is illustrated in FIG. 8. In the system of FIG. 8, the operation of the system is substantially identical to the system illustrated in FIG. 1, except that no answering machine function is provided. Instead, at step 378 false ringing continues to be played until the caller hangs up the line at which point the system also hangs up the line at step 328.

To summarize the use of the inventive system, when the consumer implements the system, as represented, for example, by FIG. 7, the consumer pushes the code button 142 and enters either the telephone number for use by caller ID or an arbitrary code number for the party who is to be given access to instrument 176. After the code has been input into the system using keys 140, the consumer repeatedly pushes alarm button 144 until the desired alarm is heard, sequentially hearing, for example, a dog barking, a duck quacking and a bird singing, or the like. Alternatively, the consumer may talk into microphone 148, immediately after pushing the alarm, and make the alarm the consumer speaking the person's name, or other identifier. A single alarm may be associated with a plurality of codes. If the alarm button 144 is not pushed after the speaking of the name, for example, of the party to be given access, the system will store the audio input by the consumer as an alarm. If, on the other hand, the alarm button is pushed, various alarms will play, and pushing of the record or enter buttons will result in storage of the identification code and the alarm last heard by the consumer. If the enter button is pushed the consumer then proceeds to the next code or, if he has completed entering all codes or simply leaves the system alone and after a time, perhaps one minute, the system shuts itself down.

Alternatively, if the record button has been pressed, the consumer speaks into microphone 148 to enter a personalized message for the caller code number previously entered. The consumer then pushes the enter button 150 to complete the operation and enter the next set of code, alarm selection, and, optionally, personalized message.

At a later point, editing may be done by pressing of the code button. When the code button is depressed, the system plays back, with an audio voice stored in RAM, the first code in memory allowing the consumer to change the alarm or message for that code. If the consumer does not wish to alter the information associated with that code, he simply presses the code button again and the system proceeds to the next code which is then made available for editing. The process is continued until all codes which the consumer wishes to change have been changed.

When a caller with a code calls, the caller (either in response to a prompt or in response to the ringing heard by the caller) enters the code to gain access to the system. In accordance with preferred embodiment, a change in the ringing may be provided to signal the readiness of the system to receive a code, as an alternative to the presentation of a message inviting the entry of a code, or the quick pickup of the line after approximately one ring.

In accordance with the invention, it is contemplated that the keypad may be replaced by a pen and tablet type input device, or the microphone may be used in connection with voice recognition software to program the inventive device.

It is also contemplated in accordance with the invention that a single signal sound, for example a dog barking may be associated with a plurality of identification codes. For example, if any of the children of the user is calling, the signal sound will be a dog barking. If any co-workers of the individual or calling, the signal sound will be a duck quacking, and so forth.

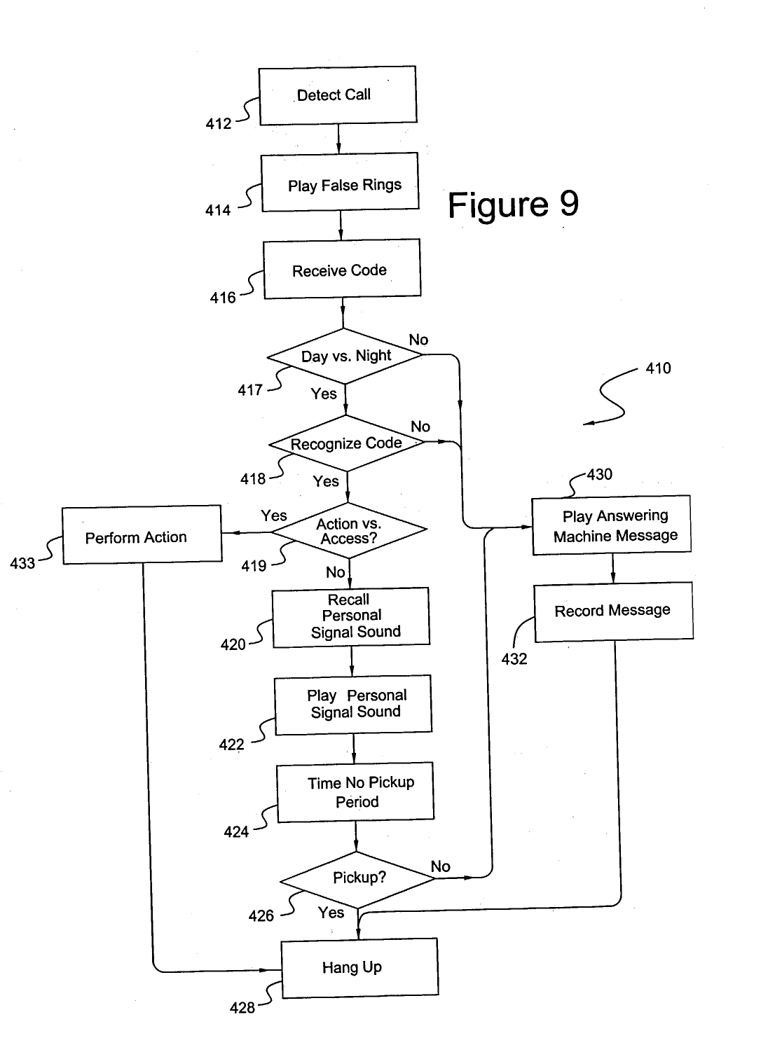

Referring to FIG. 9, the operation 410 of an alternative caller identification system constructed in accordance with the present invention may be understood. In accordance with the embodiment illustrated in FIG. 9, multiple functions may be achieved using the inventive system. In addition, the system provides for the option of varying the response of the system as a function of time of day, time of the week, or the like, as appears more fully below.

When an incoming call is detected at step 412, the system picks up the line. Next, a series of false rings are generated by the system, and these synthesized ringing sounds are played back over the telephone line to the caller. In accordance with the invention, the caller keys in a personalized code which is received by the system at step 416. Alternatively, voice recognition software may be used to recognize a password spoken by the caller and/or the identity of the person calling.

At step 417, the system determines whether it is, for example, night or day, or a weekday or weekend and implements a consumer selected program which limits the options which the system 410 will provide. For example, if desired, as illustrated, if it is night, only telephone answering machine functions may be provided at step 430. Other functions may be limited during the day or as provided below.

If the code is recognized (or if the identity of the speaker and/or the password has been recognized by the voice recognition software), at step 418. If a known code has been detected, the system proceeds to step 419 where determination is made, based on the code used, whether the caller wishes to speak to someone in the house, or, alternatively, wishes to activate a specialized function.

If the code indicates that the caller wishes to talk to a person near the telephone instrument receiving the call, the system proceeds to step 420, where the software recalls the personal signal sound associated with the recognized code. At step 422 this sound is played back by the system, for example, to a loudspeaker on the inventive device (or a loudspeaker on the telephone, in the event that the inventive device is incorporated into a cordless telephone, as will be described below). At step 424 the system measures the period of time which has passed since the system generated the personal signal sound associated with the recognized code. If, after a preselected period of time (for example five rings or playbacks of the personal signal sound), the telephone handset has been picked up by the recipient of the call, this is determined at step 426, and the system proceeds to step 428 where the device hangs up on the telephone line, leaving the recipient of the call to continue the conversation. If, on the other hand, the recipient has not picked up the telephone handset within the preselected period of time, the system proceeds at step 426 to step 430 where an answering machine message is played to the caller, followed by a prompt, such as a tone or beep. At the tone, the system is prepared at step 432 to record a message from the caller. After the message is recorded or the maximum time for a message has elapsed, the system proceeds to step 428 where the system hangs up on the telephone line.

If, at step 419, the system determines that the code relates to a specialized function, the system proceeds to step 433 where the specialized function is performed followed by the hanging up of the telephone line at the appropriate time at step 428. Such specialized functions may be playing of an alarm, a blinking light, turning the telephone on so that it acts as a speakerphone allowing the caller to monitor sounds in the room (such as the sound of a child crying, or the like), turning on a light, appliance or the like, opening a door, and so forth. For example, the inventive system may be incorporated in a telephone near a door, and at an expected time of the arrival of a child, the telephone is called, the child is spoken to over the speakerphone function of the telephone, and the door is opened. Such opening of the door may be made in response to a second code. If desired, the functioning of this code may be limited to expected time of arrival of the child.

In accordance with the invention, it is contemplated that programming of the inventive system may be done through buttons on a telephone or specialized appliance of the invention, as noted above. Alternatively, the system may be provided with a USB port which allows it to communicate with and be programmed by a personal computer provided with appropriate software, for example software on CD-ROM.

While an illustrative embodiment of the invention has been described, it is, of course, understood that various modifications will be obvious to those of ordinary skill in the art. Such modifications are within the spirit and scope of the invention which is limited and defined only by the appended claims.

1. A caller identification device, comprising:
(a) a logic circuit coupled to a telephone line and connected to receive caller identification codes;
(b) random access memory for storing information, said random access memory being coupled to said logic circuit to receive and store said caller identification codes, said random access memory having stored therein a plurality of different signal sounds, each of said signal sounds having a respective associated signal sound identifier, said signal sounds each being associated with a respective caller identification code;
(c) an input device coupled to said logic circuit, said input device configured to generate an output signal which comprises a caller identification code and said associated signal sound identifier, said caller identification code and said associated signal sound identifier being coupled to said logic circuit for storage in said random access memory; and
(d) a sound producing device coupled to said random access memory to play back a respective one of said signal sounds in response to receipt by said logic circuit of its respective caller identification code.

2. A caller identification device, as in claim 1, wherein said caller identification code is a code input by a person calling on said telephone line.

3. A caller identification device, as in claim 1, wherein said signal sounds are selected from the group comprising dog sounds, cat sounds, duck sounds, bird sounds and other animal sounds, or sounds downloaded onto the inventive device over the telephone.

4. A telephone comprising the caller identification device of claim 1 incorporated into said telephone.

5. A caller identification device, as in claim 1, wherein said caller identification code is a caller identification signal appearing on said telephone line.

6. A cordless telephone comprising the caller identification device of claim 1 incorporated into said telephone, said sound producing device being located on said handset.

7. A telephone comprising the caller identification device of claim 1 incorporated into said telephone, said telephone further comprising a headset, said sound producing device comprising the earphone of said headset.

8. A caller identification device, as in claim 1, further comprising a telephone answering circuit.

9. A caller identification device, as in claim 1, wherein said identification code is input into the caller identification device by the user of the caller identification device.

10. A caller identification device, as in claim 9, wherein said identification code is input into the caller identification device using a keypad having a button which signals that a code is about to the entered and stored by an enter key.

11. A caller identification device, as in claim 1, further comprising a line for coupling to a conventional telephone.

12. A caller identification device, as in claim 1, further comprising a telephone answering circuit.

13. A caller identification device, as in claim 12, wherein said identification code is input into the caller identification device using a keypad having a button which signals that a code is about to be entered and stored by an enter key.

14. A caller identification device, as in claim 1, further comprising a line for coupling to a conventional telephone.

15. A cordless telephone comprising the caller identification device of claim 12 incorporated into said telephone, said sound producing device being located on said handset.

16. A caller identification device, as in claim 12, wherein said caller identification code is a code input by a person calling on said telephone line.

17. A caller identification device, as in claim 14, wherein said caller identification code is a code input by a person calling on said telephone line.

18. A caller identification device, as in claim 1, wherein said identification code is input into the caller identification device by the user of the caller identification device.

19. A method of identifying a caller on a telephone instrument, comprising the steps of:
(a) programming a caller identification device by:
(i) inputting a caller identification code;
(ii) inputting an associated signal sound; and
(b) giving an indication of the identity of a caller by:
(iii) receiving a call;
(iv) receiving a caller identification code; and
(v) producing a sound associated with said caller identification code.

20. A method as in claim 19, wherein said sound is produced on a headset or a cordless handset associated with said telephone instrument.

21. A data structure in a caller identification device, comprising a plurality of signal sounds, a plurality of identification codes, each of said identification codes being associated with a signal sound.

22. A data structure in a caller identification device as in claim 21, wherein a plurality of identification codes may be associated with a single signal sound.

23. A caller identification device, comprising:
(a) a logic circuit coupled to a telephone line and connected to receive caller identification codes;
(b) random access memory for storing information, said random access memory being coupled to said logic circuit to receive and store said caller identification codes, said random access memory having stored therein a plurality of different responsive functions, each of said responsive functions being associated with a respective caller identification code;
(c) an input device coupled to said logic circuit, said input device configured to generate an output signal which comprises a caller identification code and said associated signal sound identifier, said caller identification code and said associated signal sound identifier being coupled to said logic circuit for storage in said random access memory; and
(d) responsive device coupled to said random access memory to activate a responsive function in response to detection of a known caller identification code.

23. A caller identification device, as in claim 22, wherein said responsive function comprises (i) the generation of signal sounds, each of said signal sounds having a respective associated signal sound identifier, and wherein said responsive device is a sound producing device to play back a respective one of said signal sounds in response to receipt by said logic circuit of its respective caller identification code, and (ii) an other function.
